(19) United States
(12) Patent Application Publication
(10) Pub. No.: US 2021/0158976 A1
(43) Pub. Date: May 27, 2021

(54) METHOD AND APPARATUS FOR MANAGING ABNORMAL BEHAVIOR OF IOT DEVICE

(71) Applicant: KOREA INTERNET & SECURITY AGENCY, Jeollanam-do (KR)

(72) Inventors: Sung Taek Oh, Jeollanam-do (KR); Woong Go, Jeollanam-do (KR); Hong Geun Kim, Jeollanam-do (KR); Mi Joo Kim, Jeollanam-do (KR); Jae Hyuk Lee, Jeollanam-do (KR); Soon Tai Park, Jeollanam-do (KR)

(21) Appl. No.: 16/830,195

(22) Filed: Mar. 25, 2020

(30) Foreign Application Priority Data
Nov. 25, 2019 (KR) 10-2019-0152500

(51) Int. Cl. G16Y 30/10; H04L 12/721; H04L 12/823; H04L 12/26; H04L 29/08; H04L 29/06; H04L 12/66; G16Y 40/10

(52) U.S. Cl. CPC G16Y 30/10; H04L 45/14; H04L 47/32; H04L 43/08; H04L 63/1425; H04L 69/164; H04L 12/66; G16Y 40/10; H04L 43/045; H04L 67/12

(57) ABSTRACT

Provided is a method for managing abnormal behavior of an IoT device performed at an IoT gateway connected to the IoT device. The method comprises collecting a transmission packet transmitted by of the IoT device, calculating historical time series metrics for the IoT device using the collected packet, setting normal ranges of the time series metrics using at least one of a maximum value, a minimum value, and an average value of a curvature of a curve generated based on mapping the calculated historical time series metrics onto a two-dimensional plane, and determining whether current time series metric calculated using a received packet from the IoT device are out of the normal ranges.

### CROSS-REFERENCE TO RELATED APPLICATION

This application claims priority from Korean Patent Application No. 10-2019-0152500 filed on Nov. 25, 2019 in the Korean Intellectual Property Office, and all the benefits accruing therefrom under 35 U.S.C. 119, the contents of which are herein incorporated by reference in their entirety.

### TECHNICAL FIELD

The present inventive concept relates to a method and apparatus for managing abnormal behavior of an IoT device. More specifically, it relates to a method for taking an action based on an IoT device detecting an abnormal packet among packets transmitted from or transmitted to the IoT device, and to an IoT gateway to which the method is applied.

### DESCRIPTION OF THE RELATED ART

CoAP (Constrained Application Protocol) and Message Queuing Telemetry Transport (MQTT) are being used as lightweight protocol technologies used for communication between IoT devices. Since these protocols are lightweight protocols, they are insufficient in security. Some security functions have been added for these protocols. However, since the advantage of lightweight may be abandoned to apply the security functions, the lightweight protocol technology is used in no security mode in most cases.

According to the online search engine “Shodan (https://www.shodan.io/),” MQTT-equipped devices are soaring to 6,500 in November 2017 and 26,000 in December 2017. Further, the number of CoAP-equipped devices is soaring 278,000 in May 2018, and 580,000 to 600,000 as of December 2018. Because so many devices have to run the lightweight protocol, they are operating with security problems.

### SUMMARY

Aspects of the present inventive concept provide a method for determining an abnormal packet among transmitted/received (outbound/inbound) packets of an IoT device without security enhancement update of an existing lightweight protocol, and an IoT gateway to which the method may be applied.

Aspects of the present inventive concept also provide a method for managing abnormal behavior of an IoT device capable of detecting an attack with an evasion measure so that it may not be easy to detect an attack on the IoT device, and an IoT gateway to which the method may be applied.

Aspects of the present inventive concept also provide a method for managing abnormal behavior of an IoT device capable of running on an IoT gateway with poor computing power, and an IoT gateway to which the method may be applied.

Aspects of the present inventive concept also provide a method for managing abnormal behavior of an IoT device to minimize the occurrence of false positives that may be falsely detected as an abnormal packet despite being a normal packet, and an IoT gateway to which the method may be applied.

Aspects of the present inventive concept also provide a method for detecting abnormal behavior of an IoT device in consideration of a current situation, and an IoT gateway to which the method may be applied.

Aspects of the present inventive concept also provide a method for automatically transmitting a detected abnormal packet to a control center for further analysis, and an IoT gateway to which the method may be applied.

The aspects of the present inventive concept may not be restricted to those set forth herein. The above and other aspects of the present inventive concept will become more apparent to one of ordinary skill in the art to which the present inventive concept pertains by referencing the detailed description of the present inventive concept given below.

According to the present inventive concept, a method for managing abnormal behavior of an IoT device performed at an IoT gateway connected to the IoT device may be provided. The method comprises collecting a transmission packet transmitted by of the IoT device, calculating historical time series metrics for the IoT device using the collected packet, setting normal ranges of the time series metrics using at least one of a maximum value, a minimum value, and an average value of a curvature of a curve generated based on mapping the calculated historical time series metrics onto a two-dimensional plane, and determining whether current time series metric calculated using a received packet from the IoT device may be out of the normal ranges.

According to the present inventive concept, a method for managing abnormal behavior of an IoT device performed at an IoT gateway connected to the IoT device may be provided. The method comprises collecting a packet transmitted that to the IoT device may be designated as a receiver, calculating historical time series metrics for the IoT device using the collected packet, setting normal ranges of the time series metrics using at least one of a maximum value, a minimum value, and an average value of a curvature of a curve generated by mapping based on the calculated historical time series metrics being mapped onto a two-dimensional plane, and determining whether current time series metrics calculated using the packet transmitted to that the IoT device may be designated as the receiver may be out of the normal ranges. According to the present inventive concept, an IoT gateway connected to an IoT device may be provided. The IoT gateway comprises a normal ranges setting unit for collecting at least one of a transmission packet transmitted by of the IoT device and a packet transmitted to the IoT device, calculating historical time series metrics for the IoT device using the collected packet, and setting normal ranges of the time series metrics using at least one of a maximum value, a minimum value, and an average value of a curvature of a curve generated by mapping based on the calculated time series metrics being mapped onto a two-dimensional plane, a filtering unit for determining, based on the packet being transmitted by the IoT device or the packet being transmitted to that the IoT device is a destination is received, whether current time series metrics calculated using the received packet may be out of the normal ranges.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a schematic diagram of a system for detecting abnormal behavior of an IoT device, which may be configured according to an embodiment of the present inventive concept;

FIGS. 2 to 3 are schematic diagrams of an IoT gateway according to another embodiment of the present inventive concept;

FIG. 4 is a first flowchart of a method for detecting abnormal behavior of an IoT device according to another embodiment of the present inventive concept;

FIGS. 5 to 6 are diagrams for describing some operations of the method described with reference to FIG. 4 in more detail;

FIG. 7 is a diagram illustrating an exemplary table for describing a curvature normal range of a time series metric of a normal packet referred to in some embodiments of the present inventive concept;

FIG. 8 is a second flowchart of a method for detecting abnormal behavior of an IoT device according to another embodiment of the present inventive concept; and

FIG. 9 is a schematic diagram of an exemplary computing device that may implement an apparatus or system in accordance with some embodiments of the present inventive concept.

### DETAILED DESCRIPTION OF THE EMBODIMENTS

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments may be provided so that this disclosure will be thorough and complete and will fully convey the concept of the disclosure to those skilled in the art, and the present disclosure will be defined by the appended claims.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein may be for the purpose of describing particular embodiments and may not be intended to be limiting o. In this specification, the singular also includes the plural unless specifically stated otherwise in the phrase.

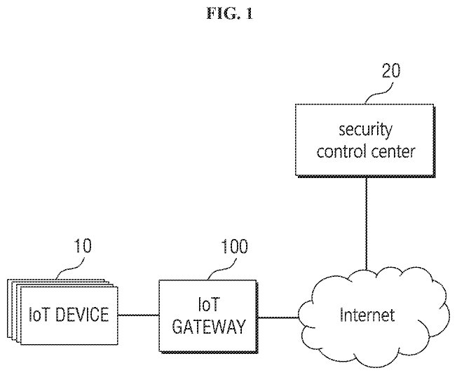

Hereinafter, the configuration and operation of a system for detecting abnormal behavior of an IoT device according to an embodiment of the present inventive concept will be described with reference to FIG. 1. As shown in FIG. 1, the system for detecting the abnormal behavior of the IoT device according to the present embodiment may include an IoT gateway 100 and one or more IoT devices 10 connected to the IoT gateway 100. The IoT gateway 100 serves to receive an outbound packet from the IoT device 10, which may be a packet transmitted by the IoT device 10 to an external device via the Internet, transmit the outbound packet to the external device using a built-in communication interface, and upon receiving an inbound packet transmitted to the IoT device 10 from the external device, forward it to the IoT device 10.

In other words, it may be understood that all outbound packets and inbound packets of the IoT device 10 pass via the IoT gateway 100. All embodiments of the present inventive concept may also be applied to edge computing devices and their connected devices having a structure via which all outbound and inbound packets of the connected devices may be passed.

Based on the IoT device 10 being infected with malicious code, the IoT device 10 shows an abnormal outbound packet transmission pattern. In addition, based on there being an external attack targeting the IoT device 10, the inbound packet of the IoT device 10 shows an abnormal packet reception pattern. As already described, in view of the inbound and outbound packets of all the IoT device 10 will pass via the IoT gateway 100, based on the IoT gateway 100 of the present embodiment receiving a packet from the IoT device 10 or an external device, it calculates a time series metric from a reception history of the packet, and determines that it may be an abnormal packet and takes a follow-up action based on the calculated time series metric being out of a normal range.

For example, the follow-up action may include at least one of dropping the abnormal packet without transmitting the external packet to the external device or the IoT device, and transmitting the abnormal packet to a security control center 20.

The IoT gateway 100 may determine whether the packet may be abnormal by using whether a curvature of a curve generated based on the time series metric being mapped to a two-dimensional plane may be out of the normal range. The IoT gateway 100 may detect transmission and reception of the abnormal packet that may be missed based on determining whether a metric depending on a packet transmission/reception pattern exceeds a reference range. The IoT gateway 100 may detect a case where the packet transmission/reception pattern shows an abnormally sharp change or there may be no abnormal change.

The IoT gateway 100 calculates historical time series metrics for the IoT device using collected packets, and sets the normal range of the time series metric using at least one of a maximum value, a minimum value, and an average value of the curvature of the curve generated based on the calculated historical time series metrics being mapped to the two-dimensional plane (first axis: time axis, second axis: metric value).

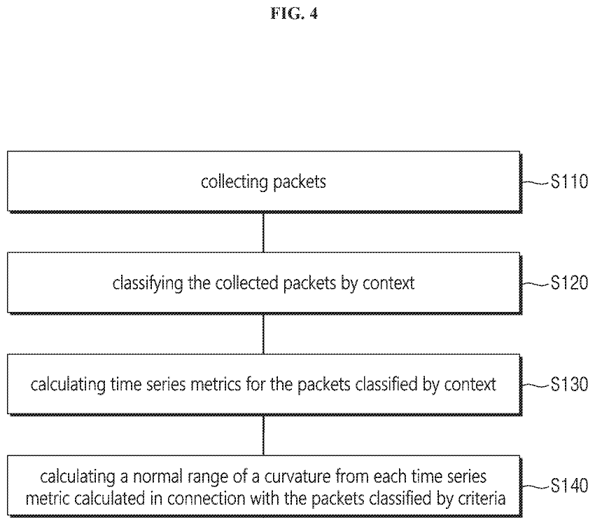

Subsequently, based on an outbound packet being received from the IoT device 10 or an inbound packet may be received from the external device through the Internet, the IoT gateway 100 collects it for a predetermined period or a predetermined number of times that a packet was received, and analyzes reception histories of the collected packets to calculate the time series metric. The IoT gateway 100 determines whether the curvature of the curve generated based on the time series metric being mapped to the two-dimensional plane may be out of the normal range. A method for detecting an abnormality of a packet will be described later in detail with reference to FIGS. 4 to 8.

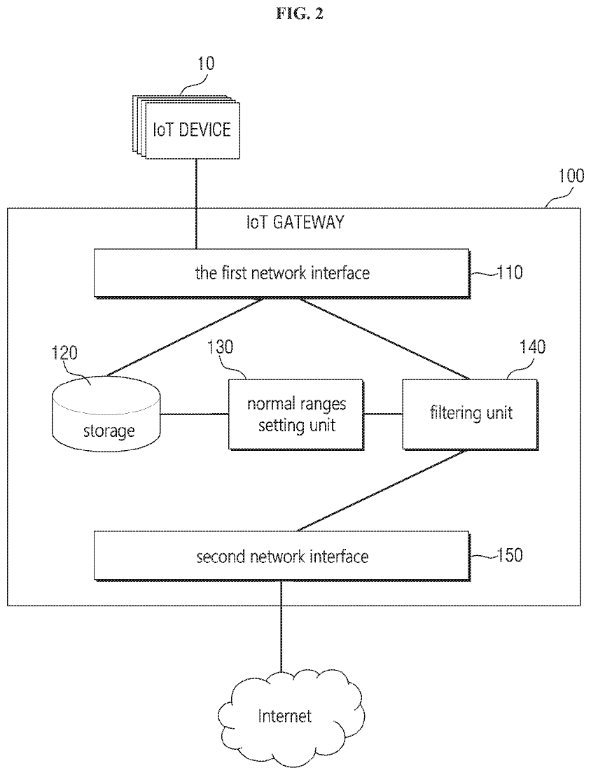

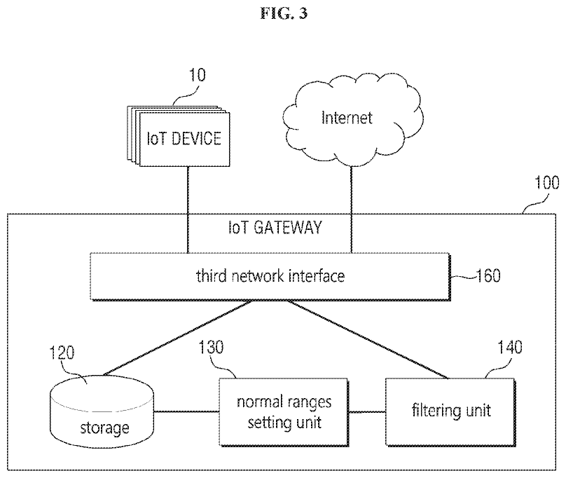

Hereinafter, the configuration and operation of an IoT gateway according to another embodiment of the present inventive concept will be described with reference to FIGS. 2 to 3. As shown in FIG. 2, the IoT gateway 100 according to the present embodiment may include a normal ranges setting unit 130 and a filtering unit 140.

In an embodiment, the IoT gateway 100 may further include a first network interface 110 that may be connected to the IoT device 10. The first network interface 110 provides wireless communication using short-range wireless communication, and may operate by, for example, a wireless communication manner such as Wi-Fi, Bluetooth, Near Field Communication, Zig bee, or the like.

In an embodiment, the IoT gateway 100 may further include a second network interface 150 that may be connected to the Internet. In other words, the second network interface 150 may be an internet interface.

In some embodiments, the IoT gateway 100 may include a third network interface 160 in which the first network interface 110 and the second network interface 150 may be integrated.

Hereinafter, in describing the operation of the IoT gateway 100 for understanding, an operation related to detecting an abnormal packet with respect to an outbound packet of the IoT device 10 will be described. The technical idea that may be understood according to this description may be equally applicable to detecting an abnormal packet targeting an inbound packet for the IoT device 10.

Based on a transmission packet of the IoT device 10 being received through the first network interface 110, the normal ranges setting unit 130 temporarily stores it in a storage 120. This may be understood as the IoT device collecting the transmitted packet.

The normal ranges setting unit 130 classifies the collected packets based on a context. The context means information indicating a situation as it may be. The context may indicate various situations at the time based on the collected packets being transmitted from the IoT device 10.

For example, the context may be any one of a packet transmission time zone, a packet transmission day, weather at the time of packet transmission, and a packet transmission season. In addition, the context may be a combination of two or more of the packet transmission time zone, the packet transmission day, the weather at the time of packet transmission, and the packet transmission season.

In addition, the IoT gateway 100 may also serve as an access point. In this case, the context may be the number of terminals (except IoT devices) connected to the IoT gateway 100. The context in this case may reflect the number of people located in a space where the IoT gateway 100 may be disposed.

One of various context settings illustrated above may be set in the IoT gateway 100.

The normal ranges setting unit 130 classifies the collected packet based on the set context. For example, assuming that the context may be the day of the week, the normal ranges setting unit 130 will classify the collected packets by day of the week.

The normal ranges setting unit 130 calculates historical time series metrics for the IoT device by using the classified packets. The normal ranges setting unit 130 may periodically perform to calculate the historical time series metrics, or may perform it based on the amount of the collected packets reaching a reference value. The amount of the collected packets may be calculated based on the number of packets or data of the packets. As illustrated above, assuming that the context may be the day of the week, the time series metric will be calculated for each day of the week.

In addition, the normal ranges setting unit 130 may calculate at least some of a first time series metric indicating the number of transmissions of packets during a reference, a second time series metric indicating an average time interval over which the packet was transmitted during the reference time, a third time series metric indicating the number of times the same payload data was transmitted during the reference time, and a fourth time series metric indicating an average time interval over which the same payload data was transmitted during the reference time. The time series metrics will be described later in detail with reference to FIGS. 4 to 7.

Next, the normal ranges setting unit 130 uses at least one of a maximum value, a minimum value, and an average value of the curvature of the curve generated based on the calculated time series metric being mapped to a two-dimensional plane to set the normal range of the time series metric. The normal ranges setting unit 130 sets the normal range to be equal to or greater than the minimum value of the curvature. For a transmission pattern of a normal packet, there should be some value variation. The normal ranges setting unit 130 may detect it as an abnormal packet even based on the degree of variation thereof being less than the normal pattern. For example, an interval between packet transmissions should be somewhat jagged. Therefore, it may be suspected that there may be an artificial external operation that the interval of packet transmissions continues to be equal to 0.1 sec.

Based on a packet transmitted by the IoT device 10 being received, the filtering unit 140 determines whether the current time series metric calculated using the received packet may be out of the normal range. For example, the filtering unit 140 may finally determine that the packet may be abnormal based on at least some of the first to fourth time series metrics being out of the normal range. In addition, in an example, the filtering unit 140 determines that the packet may be abnormal based on at least all of the first to fourth time series metrics being out of the normal range, thereby minimizing the possibility of false abnormality determination.

The filtering unit 140 may drop the received packet based on it being determined that the calculated current time series metric may be out of the normal range, or transmit the received packet to the control system of the security control center based on it being determined that the calculated current time series metric may be out of the normal range, thereby allowing to automatically report the abnormal packet to the control system.

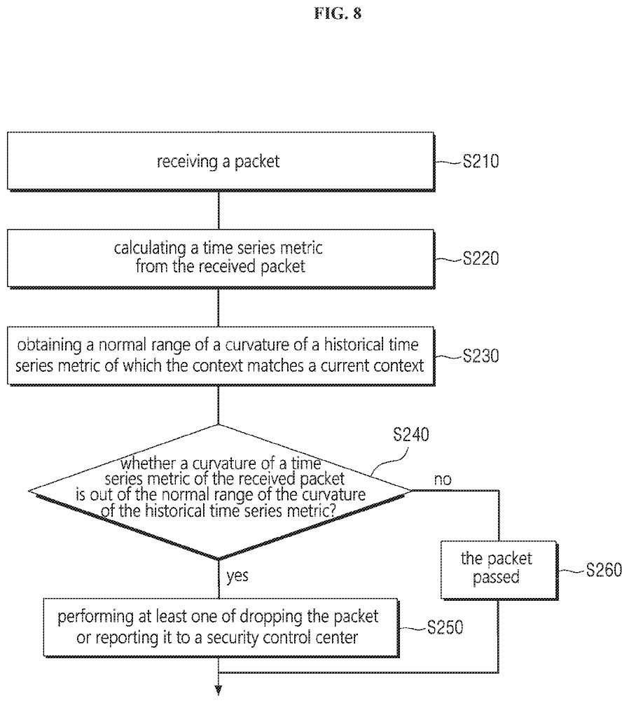

Hereinafter, a method for managing abnormal behavior of an IoT device according to another embodiment of the present inventive concept will be described with reference to FIGS. 4 to 8. To describe the present embodiment, reference may be made to two flowcharts of FIGS. 4 and 8. FIG. 4 is a flowchart illustrating a method in which a normal range of a curvature for each context and each time series metric may be calculated using collected packets, so that criteria for determining whether it may be an abnormal packet may be set later. FIG. 8 is a flowchart illustrating a method for determining whether a received packet is an abnormal packet with reference to the set criteria based on a packet being received.

The method according to the present embodiment may be performed by a computing device. The computing device may be, for example, the IoT gateway 100 described with reference to FIGS. 1 to 3, or an edge computing device that may be wired or wirelessly connected to one or more devices. It may be understood that the method may be performed by the computing device even though the subject of the operation is omitted in the description of the method according to the present embodiment.

First, a description will be given with reference to FIG. 4. For convenience of understanding, the subject of each operation may be the IoT gateway.

Packets may be collected for at least a period of time (S110). Based on the number of packets collected or a data size of all collected packets reaching a reference value, or based on an analysis cycle of the collected packets being completed, an operation of calculating normal ranges of curvatures for each context and each time series metric in steps S120 to S140 may be performed.

In step S120, the collected packets may be classified by context. Here, a time point at which a packet may be generated or a time point at which a packet may be received by an IoT gateway may be a reference time point for determining the context of the packet. For example, the IoT gateway may consider a time interval that periodically returns, such as a day of the week, a time zone, or a season, as the context.

In addition, based on the IoT gateway also serving as an access point, the IoT gateway may consider the number of access point access terminals at the time of packet generation or packet reception as the context. In this case, it has already been described that the context may indicate the number of people located in a space where the IoT gateway may be installed.

In addition, the IoT gateway may consider a data length of a payload of a packet as the context. For example, the IoT gateway may classify each packet by data length section after dividing the data length of the payload into several sections. In this case, the context may indicate the amount of information contained in a packet.

The IoT gateway may classify each packet for all of the contexts described above, or may classify each packet for some activated contexts of the contexts described above. The IoT gateway may provide a user interface for coordinating activation of the context, so that activation and deactivation of each context may be controlled by a user afterwards. The user interface may be provided to a security control center, whereby activation and deactivation of each context may be controlled by a security manager. Hereinafter, for convenience of understanding, it will be described on the premise that a day of a week, which may be one of the above-described contexts, may be activated.

In step S130, time series metrics may be calculated for the packets classified by context. Here, at least some of a first time series metric indicating the number of transmissions of packets during a reference, a second time series metric indicating an average time interval over which the packet was transmitted during the reference time, a third time series metric indicating the number of times the same payload data was transmitted during the reference time, and a fourth time series metric indicating an average time interval over which the same payload data was transmitted during the reference time may be calculated.

If existing time series metrics were stored, a newly calculated time series metric may replace the existing time series metric, or an average value of the existing time series metric may be further calculated so that the average value of the time series metric may replace the existing time series metric.

The first to fourth time series metrics may include one value per second. For example, the first to fourth time series metrics for one day of Sunday will each include a total of 86400 time series data (60 seconds*60 minutes*24 hours).

The first time series metric may be a metric for identifying a change over time of the number of outbound packets of an IoT device during the reference time.

The second time series metric may be a metric for identifying a change over time of the transmission time interval of the outbound packets of the IoT device during the reference time. Based on a plurality of outbound packets being generated during the reference time and a plurality of time intervals may be calculated, the average value may be calculated as a transmission time interval of the outbound packets during the reference time.

The third time series metric indicates the number of times the same payload data has been transmitted during the reference time. The fact that payload data of a first packet and a second packet may be the same may mean that payload data of the UDP protocol of the first packet and the second packet may be the same. The fact that the payload data of the UDP protocol of the first packet and the second packet may be the same may mean that the lower 42 bytes of the first packet and the lower 42 bytes of the second packet may be the same. The third time series metric may be calculated for each payload data. The third time series metric indicates how much the IoT device transmits the same data.

The fourth time series metric indicates an average time interval over which the same payload data was transmitted during the reference time. The fourth time series metric indicates how much the IoT device transmits the same data.

In step S140, a curvature of the first to fourth time series data may be calculated. Here, a web document (https://en.wikipedia.org/wiki/Curvature) may be further referenced. For the calculation of the curvature, the first to fourth time series data may be mapped onto a two-dimensional plane composed of a time axis and a metric axis, thereby forming a curve of a metric value. Precisely, a form in which 86400 straight lines may be connected will be formed by the mapping. However, the curve may be formed by applying a well-known method such as smoothing.

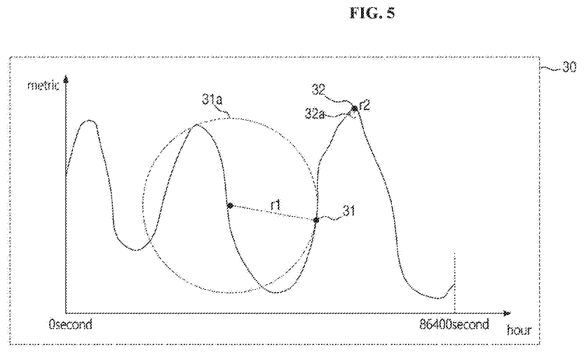

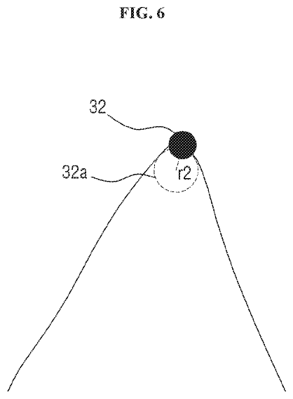

A description will be given with reference to FIG. 5. FIG. 5 illustrates that first time series data may be mapped onto a time/metric plane to form a curve. The first time series data at a first time point 31 may be increasing at a constant rate. In other words, it may be understood that, at the first time point 31, the amount of packet transmission per hour may be increasing at a constant rate. An inverse 1/r1 of a radius r1 of a contacting circle 31a of the first time point 31 becomes a curvature of the first time point 31. In addition, at a second time point 32, the amount of packet transmission per hour may be rapidly changing from the increasing trend to the decreasing trend. An inverse 1/r2 of a radius r2 of a contacting circle 32a of the second time point 32 becomes a curvature of the second time point 32. Some areas around the second time point 32 of FIG. 5 may be enlarged and displayed through FIG. 6.

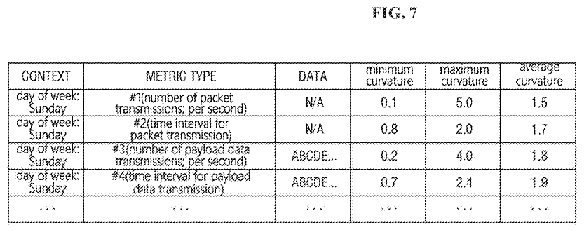

As shown in FIG. 7, in step S140, a minimum value, a maximum value, and an average value of the curvature may be calculated for each metric. A normal range of curvature may be calculated using at least some of the minimum, maximum, and average values of the curvature. For example, by calculating the normal range not to exceed the maximum value of the curvature, the outbound packet may be determined to be an abnormal packet based on a sudden change in a metric of a series of outbound packets being detected. In addition, for example, by calculating the normal range not to exceed the minimum value of the curvature, the outbound packet may be determined to be an abnormal packet based on no normal level change being detected in the metric of the series of outbound packets. In addition, for example, by calculating the normal range based on an average value of the curvature, the outbound packet may be determined to be an abnormal packet based on the change in the metric of the series of outbound packets exceeding the average level.

Next, referring to FIG. 8, a method for determining whether a received packet may be an abnormal packet by referring to the set criteria based on a packet being received will be described. For convenience of understanding, the subject of each operation may be the IoT gateway.

The received packet may be collected for a certain period of time (for example, 1 minute) (S210), and at least some of the first to fourth time series metrics may be calculated using information on a collected packet (S220).

Next, a current context may be determined depending on an activated context type set in the IoT gateway. For example, based on the activated context type being a day of a week, this means that a packet transmission/reception pattern of the IoT device varies for each day of the week. Based on a current time being Sunday, one gets a normal range of a curvature of a Sunday time series metric. For example, the normal range of the curvature may be inquired from data stored in the form of FIG. 7.

Next, in step S240, it may be determined whether a curvature of a current time series metric may be out of the normal range of the curvature. In an embodiment, step S250 may be performed as long as the first to second time series metrics all fall out of the normal range of the curvature. In this case, there may be an effect that may be prevented from being transmitted due to non-detection despite an abnormal packet. In another embodiment, step S250 may be performed based on the first to fourth time series metrics being all out of the normal range of the curvature. In this case, even though it may be a normal packet, there may be an effect that minimizes the possibility of dropping a packet due to a false positive even though it may be a normal packet. Based on it being determined that the time series metric may be within the normal range of the curvature, the packet will be passed (S260).

Some embodiments of the present inventive concept described so far have the effect of determining an abnormal packet among outbound/inbound packets of an IoT device, without requiring security enhancement update for existing lightweight protocols. In addition, even based on there being an attack with an avoidance measure that keeps metric values within a normal range so that attack detection on an IoT device (for example, based on a maximum value and a minimum value of a metric being specified) may not be easy, the effect of detecting the attack may be obtained by detecting that there may be no sudden change or abnormal change within the normal range.

In addition, it has the effect of detecting an attack on an IoT device through a way that requires less computation to run on an IoT gateway with poor computational power.

The methods according to the embodiments of the present inventive concept described so far may be performed by execution of a computer program implemented in computer readable code. The computer program may be transmitted from a first electronic device to a second electronic device through a network such as the Internet and installed in the second electronic device, and thus, may be used in the second electronic device. The first electronic device and the second electronic device include a server device, a physical server belonging to a server pool for cloud services, and a stationary electronic device such as a desktop PC.

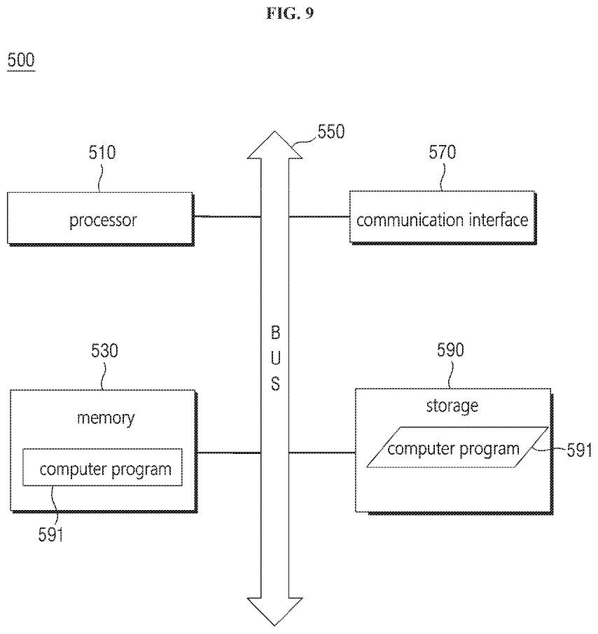

Hereinafter, an exemplary computing device 500 that can implement an apparatus and a system, according to various embodiments of the present disclosure will be described with reference to FIG. 9.

FIG. 9 is an example hardware diagram illustrating a computing device 500.

As shown in FIG. 9, the computing device 500 may include one or more processors 510, a bus 550, a communication interface 570, a memory 530, which loads a computer program 591 executed by the processors 510, and a storage 590 for storing the computer program 591. However, FIG. 9 illustrates the components related to the embodiment of the present disclosure. Therefore, it will be appreciated by those skilled in the art that the present disclosure may further include other general purpose components in addition to the components shown in FIG. 9.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. For example, based on the computer program 591 being loaded into the memory 530, the logic (or the module) as shown in FIG. 4 may be implemented on the memory 530. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure may be implemented. Based on the computer program 591 being loaded on the memory 530, the processor 510 may perform the methods/operations in accordance with various embodiments of the present disclosure by executing the one or more instructions.

Although the operations may be shown in a specific order in the drawings, those skilled in the art will appreciate that many variations and modifications can be made to the embodiments without substantially departing from the principles of the presently disclosed technology. Therefore, the disclosed embodiments may be used in a generic and descriptive sense and not for purposes of limitation. The scope of protection of the presently disclosed technology should be interpreted by the following claims, and all technical ideas within the scope equivalent thereto should be construed as being included in the scope of the technical idea defined by the present disclosure.

What is claimed is:

1. A method for managing abnormal behavior of an IoT device, the method being performed at an IoT gateway connected to the IoT device, and comprising:
collecting a packet transmitted by the IoT device;
calculating historical time series metrics for the IoT device using the collected packet;
setting normal ranges of the time series metrics using at least one of a maximum value, a minimum value, and an average value of a curvature of a curve generated by mapping the calculated historical time series metrics onto a two-dimensional plane; and
determining whether current time series metrics calculated using a received packet from the IoT device are out of the normal ranges.

2. The method of claim 1, wherein the setting the normal ranges further comprises setting the normal ranges of the time series metrics using the minimum value of the curvature.

3. The method of claim 1, wherein the determining comprises dropping the received packet based on determination that the calculated current time series metrics are out of the normal ranges.

4. The method of claim 3, wherein the dropping the received packet comprises continuing the dropping of the received packet until the current time series metrics are within the normal ranges for more than or equal to a reference time.

5. The method of claim 3, wherein the calculating the historical time series metrics comprises calculating a first metric indicating a count of transmissions of packets during a reference time and a second metric indicating an average time interval between the transmissions of the packets during the reference time,
wherein the current time series metric comprises the first metric and the second metric, and
wherein the dropping the received packet comprises dropping the received packet based on a current first metric being out of the normal range of the first metric, and a current second metric being out of the normal range of the second metric.

6. The method of claim 5, wherein the calculating the historical time series metrics further comprises calculating a third metric indicating a count of transmissions of a same payload data during the reference time, and a fourth metric indicating an average time interval between the transmissions of the same payload data during the reference time,
wherein the current time series metric further comprises the third metric and the fourth metric, and
wherein the dropping the received packet comprises dropping the received packet based on the current first metric being out of the normal range of the first metric, the current second metric being out of the normal range of the second metric, a current third metric being out of the normal range of the third metric, and a current fourth metric being out of the normal range of the fourth metric.

7. The method of claim 1, wherein the determining comprises transmitting the received packet to a control system based on determining that the calculated current time series metrics are out of the normal ranges.

8. The method of claim 1, wherein the calculating the historical time series metrics for the IoT device comprises calculating a third metric indicating a count of transmissions of a same payload data during a reference time, and a fourth metric indicating an average time interval between the transmissions of the same payload data during the reference time.

9. The method of claim 8, wherein the payload data corresponds to payload data of a UDP.

10. The method of claim 1, wherein the determining comprises determining whether the current time series metrics are out of the normal ranges based on normal ranges of historical time series metrics of which a context matches a currently activated context among the historical time series metrics.

11. The method of claim 10, wherein the IoT gateway serves as an access point, and
wherein the context is defined by a terminal being connected the IoT gateway.

12. A method for managing abnormal behavior of an IoT device, the method being performed at an IoT gateway connected to the IoT device, and comprising:
collecting a packet transmitted to the IoT device;
calculating historical time series metrics for the IoT device using the collected packet;
setting normal ranges of the time series metrics using at least one of a maximum value, a minimum value, and an average value of a curvature of a curve generated by mapping the calculated historical time series metrics onto a two-dimensional plane; and
determining whether current time series metrics calculated using the packet transmitted to the IoT device are out of the normal ranges.

13. An IoT gateway, the IoT gateway being connected to an IoT device, and comprising:
a normal ranges setting unit for collecting at least one of a packet transmitted by the IoT device and a packet transmitted to the IoT device, calculating historical time series metrics for the IoT device using the collected packet, and setting normal ranges of the time series metrics using at least one of a maximum value, a minimum value, and an average value of a curvature of a curve generated by mapping the calculated time series metrics onto a two-dimensional plane; and
a filtering unit for determining, based on the packet transmitted by the IoT device or the packet transmitted to the IoT device being received, whether current time series metrics calculated using the received packet are out of the normal ranges.

14. The IoT gateway of claim 13, wherein the filtering unit drops the received packet based on determining that calculated current time series metrics are out of the normal ranges.

15. The IoT gateway of claim 13, wherein the filtering unit transmits the received packet to a control system based on determining that the calculated current time series metrics are out of the normal ranges.
